(19) United States
(12) Patent Application Publication
(10) Pub. No.: US 2026/0085975 A1
(43) Pub. Date: Mar. 26, 2026

(54) COMPACT FIBER STRUCTURES FOR SNAPSHOT SPECTRAL AND VOLUMETRIC OCT IMAGING

(71) Applicants: UNIVERSITY OF SOUTHERN CALIFORNIA, Los Angeles, CA (US); WILLIAM MARSH RICE UNIVERSITY, Houston, TX (US)

(72) Inventors: Brian APPLEGATE, Los Angeles, CA (US); Tomasz TKACZYK, Houston, TX (US)

(21) Appl. No.: 19/111,245

(22) PCT Filed: Sep. 12, 2023
(86) PCT No.: PCT/US2023/073966

§ 371 Date: Mar. 12, 2025

Related U.S. Application Data
(60) Provisional application No. 63/405,681, filed on Sep. 12, 2022.

(51) Int. Cl. G01J 3/02; B29D 11/00; G01J 3/10; G02B 6/02

(52) U.S. Cl. CPC G01J 3/0218; B29D 11/00663; G01J 3/10; G02B 6/02033

(57) ABSTRACT

The present disclosure relates to a custom waveguide array to encode 3-dimensional data for snapshot imaging techniques like imaging spectrometry or volumetric spectral domain OCT. The custom waveguide array has a series of waveguides such as optical fibers having input ends and output ends. The input ends are grouped in a dense array input area. An array output area creates void spaces for the output ends. The output area thus may used to provide spectral information for an object imaged by the input area. The fiber arrays may be manufactured with an entirely automatic development process based on 3-D printing techniques such as 2-Photon Polymerization (2PP) additive manufacturing.

### PRIORITY CLAIM

The present disclosure claims the benefit of and priority to U.S. Provisional Application No. 63/405,681, filed Sep. 12, 2022. The contents of that application are incorporated by reference in their entirety.

### STATEMENT REGARDING FEDERALLY SPONSORED RESEARCH OR DEVELOPMENT

This invention was made with government support under Grant No. NNX17AD30G, awarded by the National Aeronautics and Space Administration (NASA). The government has certain rights in the invention.

### TECHNICAL FIELD

The present disclosure relates to waveguides. Specifically, certain aspects of the disclosure relate to an optical fiber array structure having a compact input and a dispersed output of the waveguides for an imaging system.

### BACKGROUND

Currently, Optical Coherence Tomography (OCT) is a medical imaging technology that is clinically used in vision research and diagnosis. OCT is used to a lesser extent in cardiology for intravascular imaging during placement of stents. OCT is also used for imaging the esophagus for cancer surveillance.

There are currently three primary methods of OCT to scan tissue. Flying spot OCT is a process that takes a beam, scans it across the tissue of interest, stops at each point, and takes a measurement using a mirror. All the measured points are combined to create a volumetric image. Full field OCT is a method that captures the whole field simultaneously instead of having a series of spot images taken across the tissue. Finally, a third method collects a cross-section image with each acquisition using scanning in one dimension. There are three primary interferometric methods for collecting OCT images. Two of them are different implementations in the Fourier-domain. The other is time-domain. It has been shown that Fourier-domain approaches are ˜1000 more sensitive than time-domain. Until very recently Full-Field OCT could only be done in the time-domain. Fourier-domain approaches use either a spectrometer for a detector or a frequency swept laser.

The problem with known OCT methods is that they require the use and movement of a scanner. It's challenging to capture a three-dimensional object using a two-dimensional tool. The problem with designing a Fourier-domain Full-Field system is how to map the 3-D space (x,y, lambda). It cannot be done with a traditional imaging spectrometer. A recent advancement is a laser that is used to sweep in wavelengths. Reflections of the laser are captured by advanced cameras. This laser method allows the mapping of images by time rather than by space. Though more accurate, the laser method is slow and exceedingly expansive.

Another solution has been the use of an optical fiber bundle in imaging applications. However, the formatting of an optical fiber bundle is typically challenging. One common solution is to remap the output end as a single column but this significantly limits the number of spatial samples. Also, in the prior implementations, optical fiber-based spectrometers utilized commercial fibers assembled into custom bundles. Due to the limitations of the available components, assembling the fiber bundle for the imaging spectrometer was usually a semi-manual process involving fiber assembly, cutting, stacking, gluing, and polishing. Such bundles require large/high-performance/custom optics to accommodate both the large field of view (FOV) and fiber numerical aperture (NA), usually greater than 0.25. As a consequence, the imaging system using an optical fiber bundle of available optical components is relatively expensive and large.

Further limitations and disadvantages of conventional and traditional approaches will become apparent to one of skill in the art, through comparison of such systems with the present disclosure as set forth in the remainder of the present application with reference to the drawings.

### SUMMARY

One disclosed example is an imaging system having a light source for illuminating an object. A structure of an array of waveguides. Each waveguide has an input end to capture the object and an output end. The output end of the array of waveguides is arranged having voids between the output ends allowing mapping of points of the object to the output ends. A 2-D image sensor captures the output of the structure.

In another implementation of the disclosed example imaging system, the system includes a spectrometer coupled to the outputs of the array of waveguides. The spectrometer processes the output along an orthogonal dimension. The system is an optical coherence tomography system. In another implementation, the object is one of a retina, an anterior segment of an eye, a middle ear, a tympanic membrane or an esophagus. In another implementation, the imaging system includes a dispersive component dispersing the output of the structure; and a reimaging objective lens guiding the dispersed output to the 2-D image sensor. The system is a spectrometer. In another implementation, the light source is an LED. In another implementation, the 2-D sensor is a digital camera. In another implementation, the inputs of the waveguides are lenslets. In another implementation, the outputs of the waveguides include void spaces that allow spectral information to be spread out. In another implementation, the waveguides are optical fibers having a core and a cladding surrounding the core. In another implementation, the core and cladding are one of polymer or epoxy materials. In another implementation, the fibers are fabricated from a 3-D printing process and the core diameter of the fibers is between 1-11 μm.

Another disclosed example is a waveguide structure having a plurality of waveguides, each having an input end and an output end. The waveguide structure has an input area having an input array of the input end of the plurality of waveguides. The waveguide structure has an output area having an output array of the output ends of the plurality of waveguides. The output array has greater spacing between the ends of the waveguides than the spacing between the input ends in the input array.

In another implementation of the disclosed example waveguide, the waveguides are optical fibers. In another implementation, the fibers have a core and a cladding surrounding the core. In another implementation, the core and cladding are one of polymer or epoxy materials. In another implementation, the optical fibers are fabricated from a 3-D printing process and wherein a core diameter of the optical fibers is between 1-11 μm. In another implementation, each of the waveguides include a middle segment that is bent between the input end and the output end. In another implementation, the example waveguide includes a support structure defining the input area and the output area. The support structure includes at least one internal support guiding the plurality of waveguides between the input area and the output area. In another implementation, the input array has an identical number of waveguides in an x and y dimension as the output array. In another implementation, the input array has a different number of waveguides in an x and y dimension as the output array. In another implementation, the example waveguide includes a plurality of lenslets, each optically coupled to input ends of the plurality of waveguides. In another implementation, the plurality of waveguides are grouped into rows of waveguides, and the output area separates the rows of waveguides by a predetermined distance.

Another disclosed example is a method of fabricating a waveguide array. A 3-D print file for a waveguide structure is provided. The waveguide structure includes a plurality of waveguides, each having an input end and an output end. The waveguide structure includes an input area having an input array of the input end of the plurality of waveguides. The waveguide structure has an output area having an output array of the output ends of the plurality of waveguides. The output array has greater spacing between the ends of the waveguides than the spacing between the input ends in the input array. The waveguide structure is printed from the 3-D print file by polymerizing a photoresin via a 2-Photon Polymerization (2PP) additive system.

In another implementation of the disclosed example method, the waveguides are optical fibers. In another implementation, the printing includes printing a core of the fibers and wherein the method further comprises applying a cladding material to the core. In another implementation, the printing includes printing a cladding of the fibers. The example method further includes applying a core material to the cladding to define a core of the fibers. In another implementation, the optical fibers include a core and a cladding of polymer or epoxy materials. In another implementation, a core diameter of the optical fibers is between 1-11 μm. In another implementation, each of the plurality of waveguides include a middle segment that is bent between the input end and the output end. In another implementation, the waveguide structure includes a support structure defining the input area and the output area. The support structure includes at least one internal support guiding the plurality of waveguides between the input area and the output area. In another implementation, the example method includes fabricating a plurality of lenslets optically coupled to the input ends of the plurality of waveguides. In another implementation, the plurality of waveguides are grouped into rows of waveguides. The output area separates the rows of waveguides by a predetermined distance.

Various advantages, aspects and novel features of the present disclosure, as well as details of an illustrated embodiment thereof, will be more fully understood from the following description and drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1A illustrates a block diagram of an Optical Coherence Tomography (OCT) system that includes an example waveguide array according to one or more embodiments of the present disclosure.

FIG. 1B illustrates a block diagram of optical guiding module for a lightguide image processing (LIP) based spectrometer that includes an example waveguide array according to one or more embodiments of the present disclosure.

FIG. 1C illustrates a block diagram of a snapshot spectrometer that includes an example waveguide array according to one or more embodiments of the present disclosure.

FIG. 2A illustrates the process of designing one of the fiber waveguide bundles into an example waveguide array structure;

FIG. 2B shows a close-up view of a section of the fiber waveguide bundles in the example waveguide array structure in FIG. 2A;

FIG. 2C is a microscope photo image of the bundle output from the example waveguide array in FIG. 2A.

FIG. 2D is an SEM image of the output area of the example waveguide array in FIG. 2A.

FIG. 2E is a microscope photo image and an SEM image of the side of duplicated fiber bundles in the example waveguide array in FIG. 2A.

FIG. 3A illustrates aspects of another example waveguide optical fiber array according to one or more embodiments of the present disclosure.

FIG. 3B is an SEM image of the optical fiber array in FIG. 3A.

FIG. 3C is an image of the output area of the fiber array in FIG. 3A.

FIG. 4A illustrates aspects of another example waveguide optical fiber array according to one or more embodiments of the present disclosure.

FIG. 4B is a microscope photo image of the input area of the optical fiber array in FIG. 4A.

FIG. 4C is a microscope photo image of the output area of the optical fiber array in FIG. 4A.

FIG. 5A is another example of another example waveguide optical fiber array in combination with microlenses according to one or more embodiments of the present disclosure.

FIG. 5B is a close up image of the waveguide of the example waveguide array in FIG. 5A.

FIG. 5C shows microscope photo images of different features of the example waveguide array in FIG. 5A.

FIG. 6A shows another example waveguide array according to one or more embodiments of the present disclosure.

FIG. 6B is a set of microscope photo images of the input areas of the example waveguide array in FIG. 6A.

FIG. 7 shows the process of fabricating an example waveguide array, according to one or more embodiments of the present disclosure.

FIG. 8A illustrates aspects of the optical fiber array for imaging a retina according to one or more embodiments of the present disclosure.

FIG. 8A shows one approach to optimize the fill factor for the example array in FIG. 8A.

FIG. 8B shows another approach to optimize the fill factor for the example array in FIG. 8A.

FIG. 9A shows sampling and mapping of a retina using an example array structure according to one or more embodiments of the present disclosure.

FIG. 9B is a table of spatial sampling zones of the retina in FIG. 9A.

FIG. 9C is a perspective view of the fibers of the array structure in FIG. 9A.

FIG. 10 is a set of graphs showing a comparison of the output image from an example array structure in comparison and a standard spectrometer.

FIG. 11 is a set of images showing an input image and reassembled images.

FIG. 12 shows images of an example input image, single channel images from the input image and the output image.

### DETAILED DESCRIPTION

As utilized herein the terms “circuit” and “circuitry” refer to physical electronic components (i.e., hardware) and any software and/or firmware (“code”) which may configure the hardware, be executed by the hardware, and/or otherwise be associated with the hardware. As utilized herein, “and/or” means any one or more of the items in the list joined by “and/or”. As an example, “x and/or y” means any element of the three element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.” and “for example” set off lists of one or more non-limiting examples, instances, or illustrations.

The components, steps, features, objects, benefits and advantages which have been discussed are merely illustrative. None of them, nor the discussions relating to them, are intended to limit the scope of protection in any way. Numerous other embodiments are also contemplated. These include embodiments which have fewer, additional, and/or different components, steps, features, objects, benefits and advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

Illustrative embodiments are now described. Other embodiments may be used in addition or instead. Details that may be apparent to a person of ordinary skill in the art may have been omitted. Some embodiments may be practiced with additional components or steps and/or without all of the components or steps that are described.

In the remainder of this application, unless otherwise stated, the terms “recording”, “receiving”, and “monitoring” are used interchangeably. For instance, “recording physiological or neural activities”, “receiving physiological or neural activities”, and “monitoring physiological or neural activities” imply the same.

In the remainder of this application, unless otherwise stated, there is no distinction between “generating signals”, “stimulating signals”, and “applied signals” in the context of their adverse effect on the recorded signals, and the related mitigation strategies. For instance, “cancelling the stimulation artifact on the recorded signal”, “cancelling the stimulating signal artifact on the monitored signal”, “cancelling the undesired leakage of generated signal on the received signal”, “cancelling the undesired feedback of the applied signal to the received signal” imply the same.

In the remainder of this application, unless otherwise stated, “artifact” refers to any undesirable signal that leaks into the recording system and is generated by the stimulation circuitry, which can be one or more of electrical stimulation, magnetic stimulation, optical stimulation and acoustic stimulation.

In the remainder of this application, unless otherwise stated, “biosignal”, “bio-signal”, “biological signal”, and “physiological signal” refer to any desirable signal that the recording system records.

In the remainder of this application, unless otherwise stated, “biological tissue” refers to any living tissue that can be in the form of an individual cell, or a population of cells. It can also refer to different organs in an animal or a human (e.g., brain, spinal cord, etc.) or the body as a whole (e.g., human body).

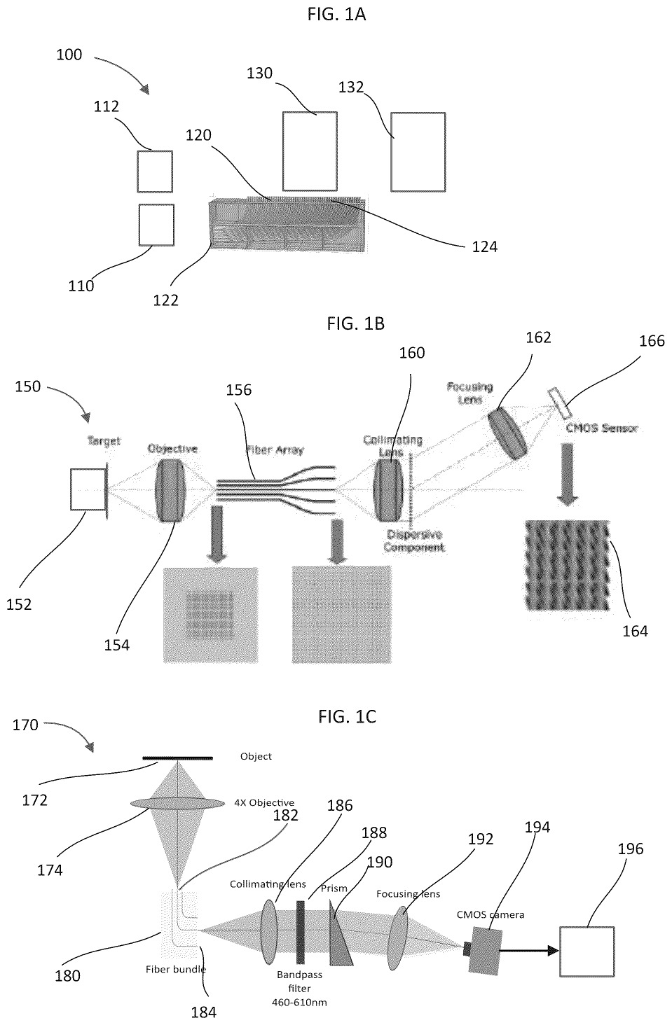

FIG. 1A shows an example Optical Coherence Tomography (OCT) system 100. The OCT system 100 allows imaging of an object 110. A light source 112 such as an LED-based light source provides light to illuminate the object 110. An example waveguide array 120 has a bundle of optical fibers on an object input end 122 arranged in a 2-D array and an output end 124 where the output ends of the optical fibers are arranged in a 1-D line. A spectrometer 130 detects spectral data from optical signals from the output end 124. An image sensor 132 is coupled to the output of the spectrometer 130. In this example, the image sensor 132 is a CMOS pixel array device such as a digital camera.

The system 100 is a high performance, compact, snapshot hyperspectral imaging system for both spectral and OCT volumetric imaging. The example array 120 is a light-waveguide having an imaging structure that is 3D printed for fine definition of the waveguides. The structure of the array 120 leverages a waveguide optical structure that is produced by 2-photon additive 3-D printing manufacturing to allow effective fabrication of custom waveguide bundles such as optical fibers. Such structures may provide different input and output organizations such as a 2-D array input and a 1-D output. These custom waveguide bundles capture densely packed input signals and yield an arbitrary output with void spaces that allow spectral information to be spread out.

A two-photon polymerization technique, which uses a focused laser beam to polymerize a photosensitive material, creates a solid structure layer by layer to enable submicron resolution and optical quality components. This simplifies the waveguide bundle fabrication process, making it possible to dramatically scale up the number of waveguides such as optical fibers, while retaining a small form factor with excellent structural integrity.

There is also more design freedom, which enables architectures that make more efficient use of the available sensor area. Practical field of view (FOV) and resolution for imaging systems require waveguide structures having thousands of fibers similar to currently available imaging bundles.

The example two-photon polymerization process may produce a 3D-printed fiber-based bundle for a snapshot imaging spectrometer system with 3,200 spatial samples (40×80 image format) and 48 spectral channels.

Thus, the array 120 converts an image from a 2D image (input) to separated spatial-spectral information (after dispersion) on a large format such as those of sCMOS/CCDs image sensors. Other 2-D imaging arrays such as an InGaAs based array may be used. The proposed approach requires no significant computation or processing to create the (x, y, λ) data cubes. Simple data re-organization will be sufficient to create spectral cubes.

The imaging system such as the system 100 use a wide field method acquiring full spectral information simultaneously from every pixel and therefore offer significant advantages in imaging speed and signal collection. Application of 2-photon 3D printing allows manufacturing of the example imaging structures. The 2-photon 3D printing process allows very compact and high spatial sampling components in comparison to traditional fibers can occupy significantly smaller output area. This is critical as common numerical aperture for bundles of fibers is relatively high and small area allows less demanding re-imaging optics as well much higher spectral sampling (necessary for OCT). The process allows different fabrication of fiber arrays comparing to traditional fiber bundle technology allows arbitrary organization of input versus output of fibers and thus different functions than common imaging arrays. The waveguide array is produced by printing cores and adding cladding material afterwards (and polymerizing) or printing the cladding and filling the cladding channel with core material. This allows easier control of core and cladding combination and thus fine tuning of fiber numerical apertures. Numerical aperture controls acceptance and output angles of the fiber/waveguide. The difference in refractive index of the core and cladding materials allows control of the numerical aperture. Thus, the example process includes selecting either the refractive index of the cladding against the refractive index of the core or selecting the refractive index of the core against the refractive index of the cladding to obtain a specific numerical aperture.

Two photon polymerization (2PP) based 3D printing enables creation of three-dimensional structures using a focused laser beam. The process utilizes femtosecond laser pulses to induce non-linear absorption of photons at the focal point, polymerizing a photoresin with sub-micron resolution. The 3D print process allows creation of complex geometries that exist within a volume, rather than on a surface, enabling the creation of optical components with unique properties beyond the capabilities of conventional or grayscale lithography. The waveguides in the example array structure may be created with air as a cladding that have extremely small core to core pitch while preserving intricate architectures, enabling high resolution imaging. The 2PP process enables an ease of design and speed of iterative development. Additionally, the 2PP process enables a high degree of control over design of waveguides as the bulk parts of the waveguide such as cladding and mechanical housing can be optimized for mass, fabrication speed, and meta-mechanical properties. An example 2PP printing system incorporating the principles described herein is the QuantumX 2-photon lithography system offered by Nanoscribe Gmbh. The system utilizes ultra-short light pulses at 780 nm with a 0.8 NA 25× objective to polymerize a voxel of photoresin to create the example waveguide array. An alternative may be a 2-photon/1 photon polymerization process to obtain the refractive index difference between the core and the cladding.

The example system 100 allows mapping a single optical fiber for every spatial position on a tissue sample such as the object 110. In an example of an grid of 100×100; instead of capturing the image in a square orientation as it would be on the sample, the image capture can be guided in a straight line with optical fibers. Once that is done, the image is processed through a spectrometer and dispersed across the free dimension. That gives a full field image at the frame rate of the camera. This method can take full-view images at integration times of 100 microseconds. The camera resolution technology is constantly advancing and getting cheaper for the image sensor 132. The LED light of the light source 112 is also cost effective.

FIG. 1B is an optical layout of an optical guiding module based lightguide image processing (LIP) spectrometer 150. First an input imaging system couples an image 152 from a side port 154 of a microscope into a LIP waveguide array component 160. The LIP waveguide array component 160 is similar to the waveguide array 120, having a 2-D input end of a bundle of waveguides and a 1-D output of the waveguides spaced apart. To maximize light coupling into the LIP component 160, its input can be preceded with a field lenslet array 156 (similarly to common solution used in CCDs to maximize light coupled into pixels). The free form 2-photon polymerization allows the fabrication of the coupling array in the same process as a bundle itself. The LIP component 160 distributes an image into small segments or pixels. In general, any arbitrary pixel distribution is allowed if it could provide a void space for a spectral spread.

In this example, the LIP components are tightly packed (stacked) fibers at the input of the LIP component 160 and sparse fibers at the output of the LIP component 160. In this example, the outputs of the LIP component 160 are dispersed via a collimating lens 162 and reimaged using a reimaging objective lens 164. The redistributed and dispersed image will be acquired in a single integration event on an image sensor 166 such as a large format CCD, CMOS, or sCMOS camera. An example large format sCMOS camera may be one available from PCO.

The operation principle of the LIP spectrometer 150 is based on a one-to-one correspondence between each voxel (volumetric pixel) in the data cube (x, y, λ) and each pixel on the image sensor 166. The position-encoded pattern on the sCMOS camera contains the spatial and spectral information within the image, both of which can thus be obtained simultaneously. No reconstruction algorithm is required since the image data contains direct irradiance from each element of the object, defined through calibration and mapped with look-up table. The dimensions of the data cube obtainable with the LIP spectrometer 150 therefore depend on the size of the image sensor. This means that the total number of voxels cannot exceed the total number of pixels on the camera. Therefore, for a given camera, the spatial sampling may be increased at the expense of spectral sampling, and vice-versa. For example, by using a 1024×1024 pixel camera, a data cube (x,y,λ) can be built either in the 256×256×16 format, or 512×512×4 (the first two numbers describe spatial sampling, and the third one is the spectral sampling). In general, the signal-to-noise ratio will be dependent on the camera quality.

The resolution/sampling of the LIP component 160 depends on the selected detector and fore optics (e.g., microscope and LIP coupling objective lens). The overall throughput of the LIP component 160 is highly dependent, however, on re-imaging conditions of the output of the fiber bundle.

FIG. 1C shows a block diagram of an example snapshot imaging spectrometer system 170. The system 170 allows imaging of an object 172. The example snapshot imaging spectrometer system 170 acquires spatial and spectral information from the object 172 in a single image acquisition. Advantages such as high optical throughput and no scanning, make it ideal for low light level or dynamic scenes. As one class of snapshot spectral imagers, an integral field spectrometer (IFS), provides direct information with limited post processing. The system 170 is based on an example custom array 180 of an optical fiber bundle produced by 3-D printing. In fiber-based spectrometers, the object is imaged onto a spatially dense input and is transformed to a spatially sparse output. The output is imaged through a dispersive element where the void spaces created by the bundle accommodate the spectral information of the object. Overall, the optical layout (reimagining system with disperser) is simple and compact.

The object 172 is magnified via an objective lens 174 and transmitted to an example optical guiding array 180. The waveguide array 180 has a bundle of fiber waveguides each having inputs arranged in an array input 182. The waveguides of the array 180 each have an output end that are spaced apart to form an output end 184. In this example, the output from the waveguide array 180 is fed into a re-imaging system that includes a collimating lens 186, a bandpass filter 188, a dispersive prism 190, and a focusing lens 192. The output from the focusing lens 192 is captured by an imaging sensor 194, such as a CMOS camera PCO edge 5.5 camera.

The object lens 174 in this example is a Nikon 4X finite conjugate objective MSB50040 (NA=0.1, WD=25 mm) used to magnify or de-magnify objects to the input end of the fibers making the input (240 μm×480 μm) of the waveguide array module 180. The collimating lens 186 is a MVPLAPO 1 X (Olympus, NA=0.25, f=90 mm). The focusing lens 192 is a MVX-TLU (Olympus, f=180 mm) give a total magnification of 2. The dispersive prism 190 is a P-WRCO43 (Ross Optical) with a 6-degree deviation angle made by BK7.

First, the target is imaged to the input end of the fibers of the waveguide array module 180 (FOV=240 μm×480 μm) through a microscopic slide by the microscopic object lens 174. The output is then imaged by a re-imaging system having the collimating lens 186, the focusing lens 192 and dispersive prism 190 onto the camera 194.

The bandpass filter 188 is used to select the 460-610 nm band with average transmission >93%. The output is reimaged onto the camera 194 with a magnification of 2. The dispersed image is acquired on a PCO edge 5.5 sensor.

Acquired images need to be remapped to a spectral data cube. A look-up table is created in the calibration process to map spectral spatial locations of the object. The raw images are spatially and spectrally calibrated, flat-field corrected, and background subtracted to generate the multi-spectral images. The calibration process, correction process, and background process are performed by a processor 196 running an image processing routine. Due to very regular and controlled example waveguide structure architecture, the calibration routine is simplified. The calibration requires locating fiber cores (spatial) at different wavelengths (spectral). A flat field is used to compensate for signal difference between fibers for uniform illumination.

An advantage of the 3D-printed fiber structure of the waveguide array module 180 is regularity of the optical fibers. This simplifies the calibration process compared to currently used semi-manually fabricated bundles of fibers. The image region property functions of MATLAB are applied with a proper bounding box and threshold setting to find the centroid of the bright pixels on the image with a narrowband filter. Spectral calibration is used to locate all 48 spectral channels by repeating the same steps for three narrowband filters. The dispersion angle on the sensor is designed to be 64-degree with respect to horizontal axis in order to reduce the output pitch and total height of the structure in this example.

A flat-field image (F) is necessary to compensate for the intensity difference of individual fibers/fiber rows. The flat-field image is taken by replacing the target object with white paper under the same illumination conditions. A dark-field image (D), which is captured when the illumination source is covered, is also required for background subtraction. The flat-field corrected image (C) for scene image(S) is then obtained from the following equation:

$$C = S - D / F - D$$

where S is a measurement image (object/sample image), D is a dark image (no object no illumination), and F is a flat field image (image taken for uniform system illumination. Thus, the process is to acquire images F and D with a camera before the tests. S is an experiment image.

In this example, the waveguide array 180 has 40 rows of 80 optical fibers. Each of the rows of optical fibers is spaced from the other rows in the output end 184.

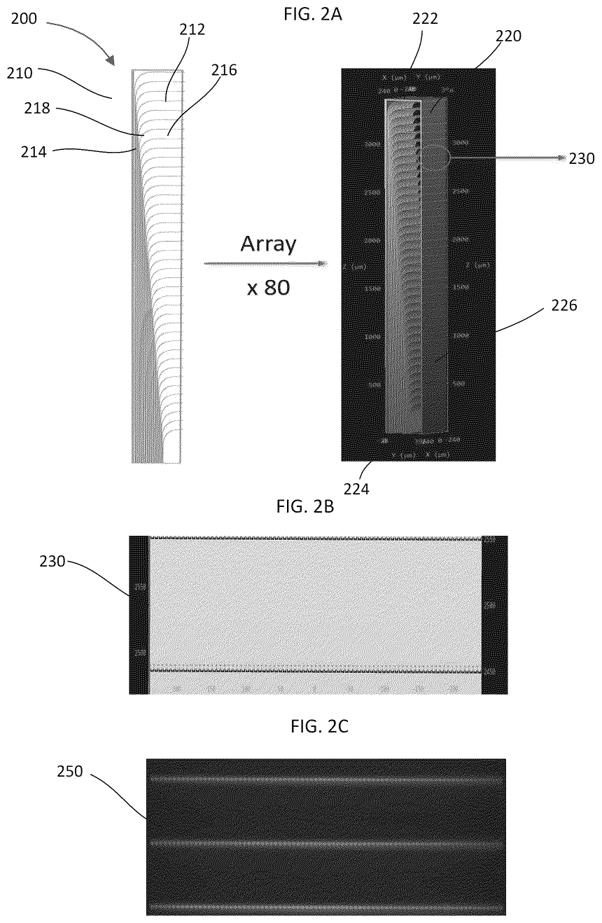

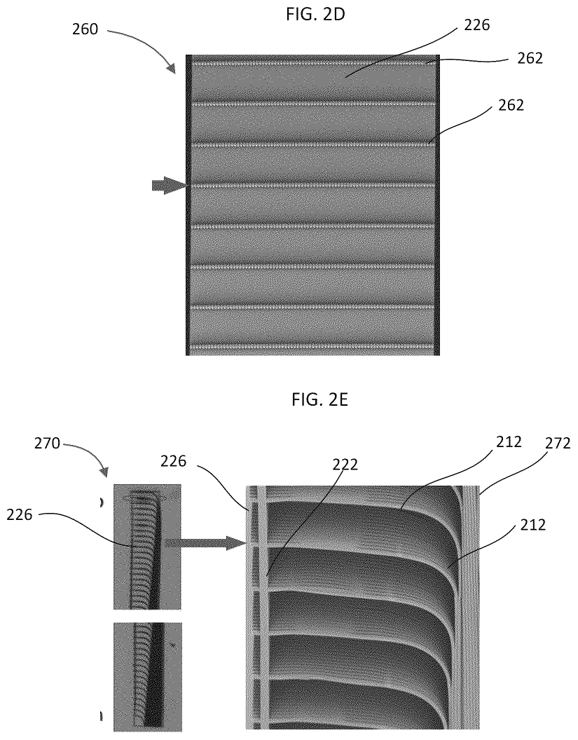

FIG. 2A shows the process of designing an example 3D printed waveguide array 200 for use in one of the examples in FIGS. 1A-1C. The example 3D-printed array 200 is designed as a repeated structure of optical fibers that utilizes a single printing field of view (FOV). In a first phase (210) one layer of fibers 212 are made of three segments: two straight segments 214 and 216 and one 90-degree turning segment 218. This example is a simple design that can achieve a dense input and a sparse output for a large fiber array.

In this example, the one layer of a fiber bundle (40×1) 212 is generated by a 3D modeling software application such as Mathematica. The layer of fibers 212 is duplicated 80 times in a 3D printing software application such as DescribeX (the native software of Nanoscribe) with the array function to produce a layered bundle design 220. The bundle design 220 includes supporting walls 222 that define an input area 224 and an output area 226.

FIG. 2B shows a close up view of a section 230 of the bundle output area 226. Each fiber is designed to be in contact with the walls 222 only at the input area 224 and close to the output area 226. Hence, only the length of the fibers differs. There are two advantages of the design in general: reduced background noise and enhanced mechanical stability. The turn segment of the fibers reduces the background signal from the bundle input area 224.

FIG. 2C show a microscope photo image 250 of a section of the bundle output obtained with a bright-field microscope. Using a single printing, the FOV of the resulting array avoids stitching artifacts which can cause misalignment between layers. Stitching errors can reduce fiber throughput and compromise mechanical stability of the array. The area of the output may be increased to expand spatial sampling by a stitching process. Such an increase requires a custom system calibration process to compensate for stitching.

FIG. 2D shows an SEM image 260 of the output area 226 showing rows of output ends 262 for each of the bundles of fibers. FIG. 2E shows a microscope photo image 270 and an SEM image 272 showing the side of the duplicated fiber bundles in the array 220. As may be seen, there is space between each of the rows of fibers 212 in the output area 226 with selected wider layers toward the output area. This becomes more pronounced from the SEM image 272 with a 45-degree view.

In this example, the fiber diameter is set at 5 μm (this value allows 80 fibers in one FOV) and bending radius to be 150 μm which exceeds the critical radius to ensure no radiation loss. The fibers have a symmetric 6 μm pitch (5 μm core+1 μm gap) on the input side and 6 μm(x) by 80 μm (z, 5 μm core+75 μm void space) pitch on the output. Output pitch in z-direction determines how much void space can be used for spectral channels. The entire structure has dimensions of 480 μm(x)×424 μm(y)×3456 μm(z), which fall within the FOV of 495 μm(x)×495 μm(y) of the 25× objective (NA=0.8) used in the Nanoscribe GmbH Quantum X system. The system also utilizes femtosecond light pulses at 780 nm. Both hatching (lateral) and slicing (axial) distances are 0.3 μm with laser power set to 60 mW, and scanning speed set to 120000 μm/s. The roughness/form of the surface is determined by the hatching and slicing distances, with the trade-off that using smaller values extends the fabrication time. The combination of laser power and scanning speed determines the exposure dose. A lower dose results in reduced mechanical strength of the fiber array and raising the risk of structural collapse during post-processing. A parameter sweep for these two parameters is then applied to avoid this issue, also considering the surface quality (roughness/form). Consequently, the printing process takes approximately 24 hours to complete. The fiber structure 220 is fabricated using IP-S photoresist offered by Nanoscribe that is polymerized by the 3-D printing process. Other materials such as epoxies may also be used. Post-processing of the structure consisted of immersion in SU-8 developer for 20 minutes followed by 2 minutes in IPA to wash away the unpolymerized resin. In this example, when fabricating a waveguide, the core is formed from polymerized IP-S as it has the highest refractive index available, and the cladding can be air, unpolymerized IP-S, or an externally added epoxy. In this example, the core diameter may be between 1-11 μm, based on near UV to short wave IR (˜300-1700 nm). This range of core diameters allow generating fibers that will be single mode (or multi-mode) with practical numerical apertures (˜0.1-0.8). Likewise, they are small enough that they can be packed close together for dense sampling.

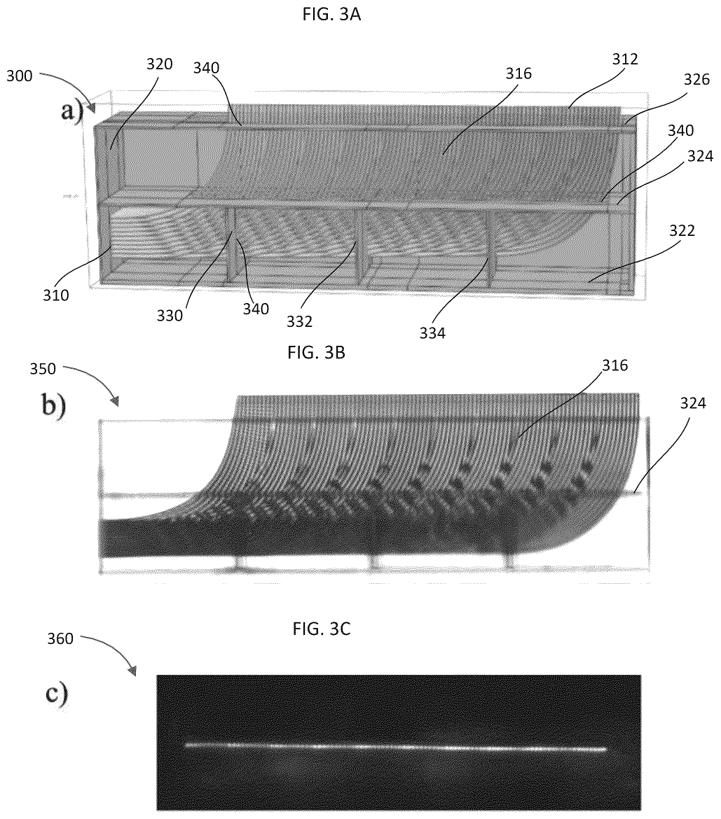

FIG. 3A shows a model of a 10×10 example waveguide array 300 that may be used for the imaging systems described above. FIG. 3B shows an SEM image 350 of the printed array 300. FIG. 3C shows an image 360 of the output area 312 showing light propagating through the fiber array 300. The waveguide array 300 may be fabricated from an entirely automatic development process based on 2-Photon Polymerization (2PP) additive manufacturing using Nanoscribe GmbH Quantum X system. The array 300 has dense fiber spacing (1-2 microns fiber gap).

The image of the array 300 in FIG. 3A is taken from a Mathematica design which remaps a 10×10 array on an input side 310 to 1×100 on an output side 312. Of course any appropriate math/3D coding software with similar functions to Mathematica may be used to produce the image of the array 300. The example fiber array 300 consists of 100 fibers, with a 10×10 input and a 1×100 output. Thus, the fiber array 300 includes the object or input side 310 having the inputs of the 100 fibers arranged in the 10×10 array. The output side 312 has the outputs of the 100 fibers arranged in a 1×100 array. A series of bundles of waveguides 316 such as optical fibers are fabricated with a bend between the input area 310 to the output area 312.

A support structure 320 with support walls is printed with the array 300. The support structure 320 includes lateral supports 322, 324 and 326. The lateral supports 324 and 326 serve to guide the bundles of waveguides 316. Three vertical supports 330, 332, and 334 join the lateral support 322 to the lateral support 324. The fiber cores in this example are 5 μm in diameter. The array support structure 320 is printed with the structural supports 322, 324, 325, 330, 334, and 336, however these supports are not in contact with the fibers 316. Thus, apertures 340 are cutout in the supports 324 and 326 and vertical supports 330, 332, and 334 to allow passing of the fibers 316 therethrough. Supporting 1 μm diameter rods are provided in the apertures 340 to minimize the support contact with the fibers 316 and therefore minimize losses from the fiber. The diameter of the rods may be reduced to less than the wavelength of the light source with an approximate limit of 500 nm.

In the example support structure 320 three to five lateral and vertical supports 324, 326, 330, 332, and 334 are used on each fiber 316. In this example, the diameter and number of supports is optimized. The print time of the example array structure 300 is 30 to 90 minutes depending on structure orientation (in the printer) and printing parameters.

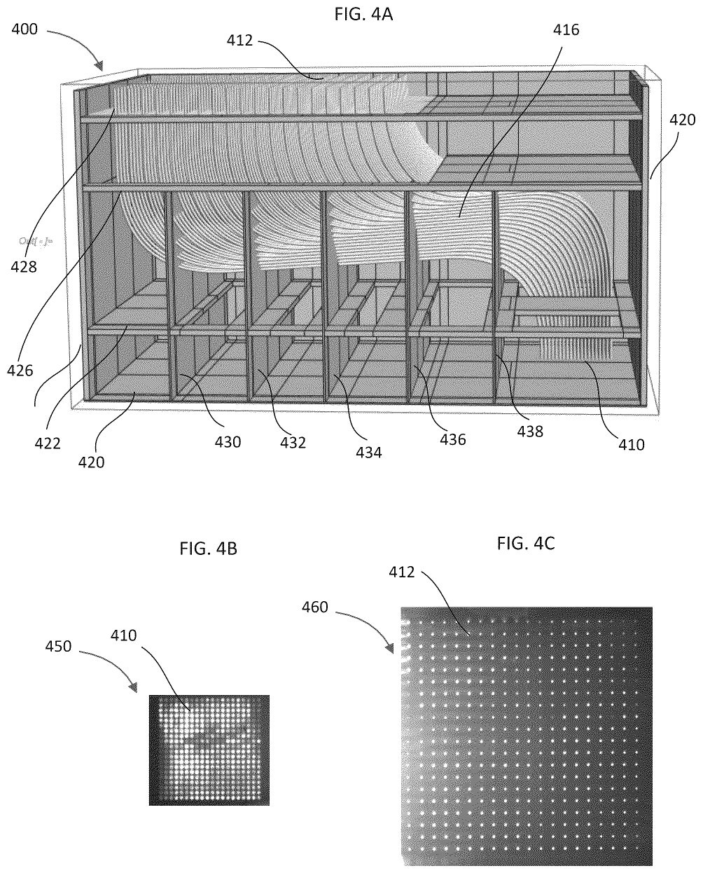

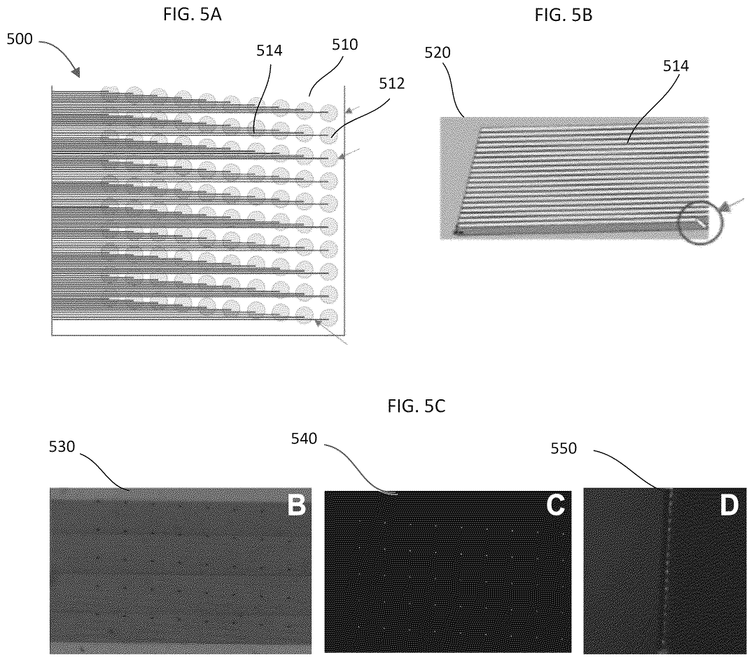

FIG. 4A shows an example 20×20 fiber array 400 that may be used with spectroscopy imaging systems such as those in FIGS. 1A-1C. The array 400 is a compact structure with 400 fibers in total. The whole structure of the array 400 is not covered with a wall to increase the liquid flow during the printing process and eliminate undeveloped resin such as IP-S from the printing process.

FIG. 4B shows a microscope photo image 450 of the input area of the printed array 400. FIG. 4C shows a microscope photo image 460 of the output area 412 showing light propagating through the fiber array 300. The image of the array 400 in FIG. 4A is taken from a Mathematica design which remaps a 20×20 array on an input side 410 to 20×20 array on an output side 412. Of course any appropriate math/3D coding software with similar functions to Mathematica may be used to produce the image of the array 400. Thus, the fiber array 400 includes the object side 410 having the inputs of the 400 fibers arranged in the 20×20 array. The output side 412 has the outputs of the 100 fibers arranged in a 20×20 array with larger spacing between the outputs of the 400 fibers than the inputs. A series of bundles of waveguides 416 such as optical fibers are fabricated with a bend between the input area 410 to the output area 412.

A support structure 420 with support members is printed with the array 400. The support structure 420 includes lateral supports 422, 424, 426, and 428. The lateral supports 424, 426, and 428 serve to guide the bundles of waveguides 416. Five vertical supports 430, 432, 434, 436, and 338 provide support for the lateral supports 324, 326, and 328. The fiber cores in this example are 5 μm diameter and have a bending radius of 200 μm. The overall dimensions are 985 μm(x)*575 μm(y)*552 μm(z). The input pitch is 7 μm and the output pitch is 25 μm. The hatching and slicing are 0.3 μm in this example.

The array 400 may be fabricated from an entirely automatic development process based on 2-Photon Polymerization (2PP) additive manufacturing using Nanoscribe GmbH Quantum X system with a printing time of around 7 hours. The array 400 has sparse fiber spacing (30-40 micron fiber gap) in comparison to the 1.2 micron fiber gap in the array 300 shown in FIG. 3A. In this example, the print volume is larger than the field of view (FOV) of the objective. Thus, stitching of prints is necessary for volumes larger than FOV and depth of field (DOF). In some cases stitching artifacts may occur at the volume boundaries. Careful calibration over FOV and compensation of laser power solve the artifact issue.

FIG. 5A shows another example fiber array 500 that is a 10×10 array. The array 500 is formed on a substrate 510. The substrate 510 has rows of microlens 512 that are formed in the substrate 510. Each of the microlens 512 has a corresponding individual waveguide 514. The reverse side of the substrate 510 forms the input from an object. The opposite ends of the waveguides 514 from the microlenses 512 form the output of the fiber array 500.

FIG. 5B is a closeup image 520 of the waveguide 514. In this example, the waveguide 514 has a 45 degree ramp to redirect light from the microlens 512. FIG. 5C shows a microscope photo image 530 of a planar waveguide array, a microscope photo image 540 of waveguide ends terminated with 45 degree ramps, and a microscope photo image 550 of waveguide input to a planar array for illumination through output.

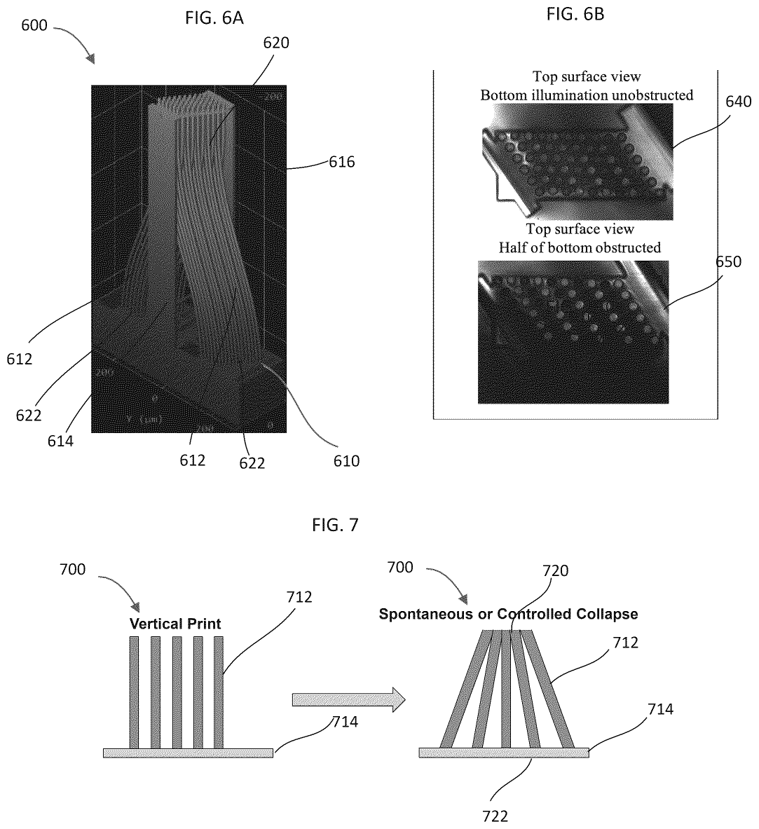

FIG. 6A shows another example fiber array 600 that may be used for the systems in FIGS. 1A-1C. The fibers in this example are 10 μm core diameter with 5 micron air cladding fibers. In this example, the array 600 includes a base 610. Two separate groups of fibers 612 are printed from the base 610. A pair of lateral supports 614 and 616 are formed from the base 610. One end of the fibers 612 are consolidated into an input end 620. The opposite ends of the fibers 612 that are formed in the base 610 define a first output end 622 and a second output end 624 of the array 600. Thus, the input is a 6×10 array, with two 3×10 output areas.

FIG. 6B shows a first microscope photo image 640 of the input end area 620 when the ends 622 and 624 are both illuminated. A second microscope photo image 650 shows the input end area 620 when one of the ends 622 and 624 is not illuminated and thus only half of the fibers guide light.

Fibers can be fabricated by either directly printing the core or directly printing the cladding. The direct fiber print requires little to no post processing. Air can be immediately used as cladding or appropriate epoxy applied (e.g., NOA148). Alternatively, an air core may be used with a solid cladding. Cladding printing requires application of epoxy (e.g., NOA61) to a formed core. The print is structurally robust and for example IP-S resin available from Nanoscribe may be used for a refractive index of 1.515 when polymerized.

FIG. 7 shows the process of fabricating a waveguide array 700 that creates a dense input end and an output area having voids between the ends of the waveguides. Initially, a set of fibers 712 are formed from a base 714. One end of the fibers 712 are bent or collapsed and brought together to form an input end 720. The opposite end of the fibers 712 are formed in the base 714 and define an output area 722.

Compact snapshot imaging spectrometers with high overall spectral/spatial cube sampling necessary for OCT may incorporate principles disclosed herein. The principles may also be applied for vision diagnostics. For example, patients are usually asked to fixate on a point in space to determine any underlying vision issues. However, individuals with conditions or diseases that make it challenging to fixate cannot be adequately assessed.

Imaging of biological tissue such as organs is an important application of OCT. OCT may be applied for imaging a retina, an anterior segment of an eye, a middle ear, a tympanic membrane or an esophagus for example. The disclosed system 100 in FIG. 1A improves OCT system performance over currently available approaches in several key ways: high-speed, high image/phase stability and low cost. The entire volume image is collected in one camera exposure time and thus the effective volume acquisition times are very short. For instance, the example system 100 can collect a volume with 80,000 lines with an integration time of 200 μs. A conventional flying spot system would need to have a line rate of over 400 MHz to collect a similar sized volume image in the same amount of time. This represents 4,000-fold speed improvement over current state-of-the-art commercial retinal imaging systems such as the Zeiss Cirrus 6000 that has a line rate of 100 KHz.

Given the market pressures from consumer, industrial, and military products, the speed and size of available cameras will likely continue to trend up with cost trending down. The high speed imaging is clinically relevant as it prevents artifacts due to eye motion. The integration time is much faster than the rate of micro-saccades, which impact image quality in commercial OCT systems. Poor or intermittent patient eye fixation will not gravely impact image quality, hence this technology will produce superior images for patients with poor fixation, opening up the technology to a larger population of eyes. This is important in pediatric patients and patients with visual defects in their central field, and patients with high refractive errors.

The example system 100 also allows high stability. The fact that the entire volume image is collected in a single camera exposure, guarantees that the magnitude and phase of the complex OCT image is stable among individual A-lines. Even if there is eye motion during the camera integration time, the motion is common to all A-lines, hence they are impacted in a similar way. This type of stability is important for a number of OCT extensions, including angiography, digital wavefront correction, digital refocusing algorithms, and elastography. The most recent generation of clinical OCT systems have incorporated angiography, (OCTA), as a standard imaging mode. Clinically, this will allow for better contrast to noise in OCTA, enabling mapping of slower flow vasculature.

The two most expensive components in most OCT systems are the light source and the detector. The light sources typically used for Full-Field OCT, e.g., halogen lamps, LEDs, are ˜10× less expensive than a swept laser source and ˜2-4× less expensive than low end super-luminescent diodes (SLD) typically used for swept source and spectral domain OCT, respectively. Consumer, industrial, and military product demand continues to push up the size of 2-D CMOS sensors while holding down or reducing the price. For instance, Canon has recently developed a 250 MP array that could potentially be used in future versions of the proposed technology. Some models of the Samsung Galaxy smartphones come with a 108 Mp camera. The FF-OCT approach described here benefits from these trends, which would drive it to become the least expensive version of OCT while simultaneously offering high imaging speeds and comparable or better image quality.

The single greatest cost in the example system is the CMOS sensor. Ultimately these could be replaced by the 108 Mp Samsung camera or other cameras, thus reducing costs. There is potential to further reduce this cost and improve manufacturability by developing a spectrometer with custom integrated optics. Clinical implications for low cost include wide spread use in cost sensitive environments, e.g., screening in an office of an optometrist or a general practitioner, underserved or rural US populations and developing countries. This approach could eventually be integrated into a smartphone enabling broader applicability at dramatically lower costs than the current state-of-the-art.

The present disclosure uses additive manufacturing to create optical structures that enable a new approach to Full-Field snap shot Optical Coherence Tomography. In this approach, light returning from the interferometer is carefully remapped using a complex optical structure to map points on the object (xo,yo) to the camera detector pixels (xd,yd), such that a spectrometer can disperse the light without overlapping spatial samples.

As an example, an object is sampled in a 10×10 square that is 100 samples. These samples are remapped such that each sample falls along a single line, i.e., xd, yd to form a line of 100 samples. The spectrometer is set up to disperse along the orthogonal dimension so that the 2-D sensor effectively samples the 3-D space (x,y,l). Hence, for spectral domain OCT, this technique enables the collection of a volume image with no scanning mirrors or other moving parts, at the frame rate of the sensor.

In previous work with a similar approach, complex diamond turned mirrors were utilized for mapping xo, yo into xd,yd. The manufacture of the mirrors, among other issues, was very time consuming (˜1.5-2 weeks to manufacture for low resolution components) making it very difficult to optimize.

The example approach allows a 3-D printed array of single mode fibers to map xo, yo to xd, yd. Using waveguides for remapping spatial samples provides much more flexibility in design since light need not travel along straight lines.

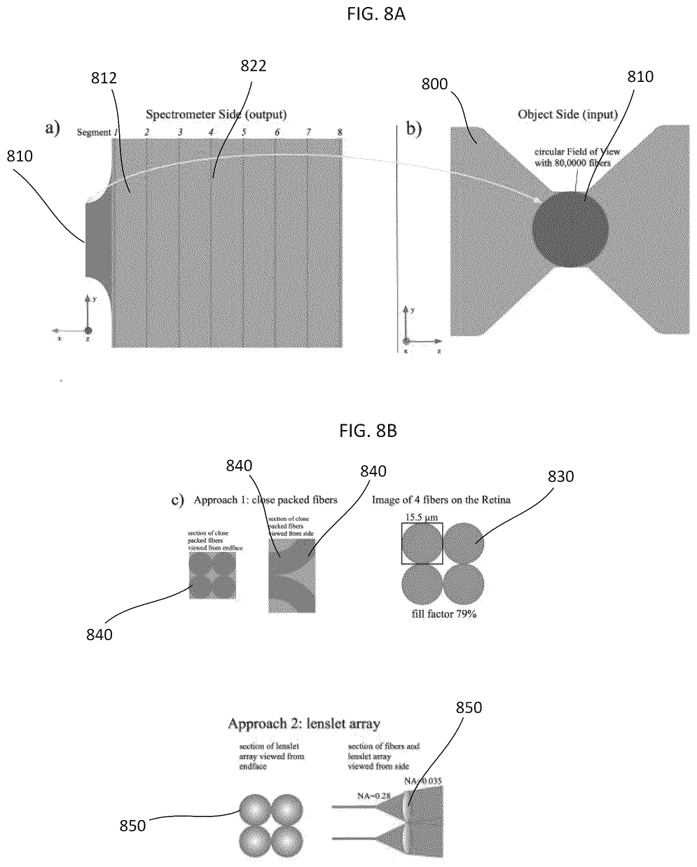

FIG. 8A shows a conceptual drawing of mapping of an object from an example array 800 with an object or input side 810 and an output or detector side 812. A circular field of view 820 is imaged onto the sample of an object such as a retina. The samples in the circular field of view correspond to waveguides which are directed at the output to form the lines 822. The detector side 812 may be output to a detector such as a spectrometer. Eight vertical lines 822, labeled segments, on the spectrometer side 812 of the structure 800, map to the object side 810 of the printed fixture, similar to what is shown for the square field of view (FOV) in the array 300 in FIG. 3A. In this example, the vertical spacing between the printed fibers in each line is 3.2 μm, chosen to match pixel pitch (3.2 μm) of the CMOS image sensor (8192×5460), permitting the spectrometer (described below) to be designed with an overall magnification of 1. The example design includes a 24 pixel buffer on either side of each segment and 230 pixels at the top and bottom of the image array. This is meant to provide some flexibility in spectrometer alignment. Of course, other different sized pixel buffers and arrays may be used.

An optical fiber such as the fiber cores in FIG. 3A consists of a core (inner cylinder) and cladding (outer coating). The relative refractive index of the core and cladding are key to tuning the performance of the optical fiber. A key innovation in the context of additive manufacturing of optical fibers is that the core or the cladding may be printed, and then an epoxy of the appropriate refractive index may be back filled to control the performance of the fibers.

Additive manufacturing of optical fibers is advantageous because the path of every fiber in a compact multi-core fiber structure may be controlled. This allows much more compact multi-channel structures than can be made using traditional approaches with optical fibers, mirror systems, and lenslet arrays.

This also allows production of multi-channel structures that incorporate optical components (also 3D printed) such as a fiber coupler and fiber circulator. The ability to make these compact multi-core structures opens up numerous applications where a spatial position on one side of the structure is mapped to a different spatial position on another side of the structure. A specific application for Optical Coherence Tomography is described above in reference to FIG. 1A. Other compact applications incorporating the example array structure in an imaging spectrometer may encompass applications spanning from biomedical imaging, environmental imaging and remote sensing, etc. Since the example fiber bundle in the array is on the millimeter scale, it allows miniaturizing entire imaging systems that may be incorporated into portable handheld devices or small unmanned aerial vehicles (UAV).

In order to achieve single mode performance, an epoxy with a carefully chosen refractive index is needed for the cladding. The example design sets the fiber core diameter at 2.2 μm, but other core diameters may be used. Given that the printed material has a refractive index of 1.507, if an epoxy with a refractive index of 1.48 (e.g., Norland, NOA 148) is chosen, single mode performance is achieved with a single mode cutoff wavelength of 816 nm, NA of 0.28, mode field diameter (MFD) of 2.5 μm, and critical bend radius of 765 μm. Nanoscribe materials such as IP-dip or IP-S as well as standard resists such as SU-8 may be photosynthesized for the 2PP process. Optical epoxies such as NOA can be used after printing to be added as a cladding or a core. Within the spectrometer with M=1, the 2.5 μm MFD will be imaged to a 2.5 μm spot onto the 3.2 μm square pixels of the CMOS image sensor.

The light source illuminates the object in FIG. 8A. In this example, light from an LED is made to illuminate a 5 mm diameter circle on the retina. The LED light is collected and imaged onto the object side 810 of the printed fiber array 800. In order to ensure efficient collection of light there are two alternate approaches to optimize the fill factor for the printed fixture of the fiber array 800. FIG. 8B shows a fiber approach while FIG. 8C shows a lenslet approach. In both approaches, a square 15.5 μm section of the retina is imaged onto the circular aperture formed by a fiber. That produces a fill factor equivalent to the ratio of a circle with 15.5 μm diameter and a square with 15.5 μm sides, i.e., 79% as shown in an image 830. In the first approach in FIG. 8B the thickness of the cladding is reduced to ˜0 at the Object Side 810. FIG. 8B shows a grouping of four fiber cores 840. A side view 842 of the fiber cores 840 shows the curved segments of the fiber cores 840. The close packing of the cores 840 result in cross-talk between cores. This is minimized by quickly increasing the cladding thickness as the fibers recede from the end face on the object side.

Cross-talk may be tested by printing test systems with close packed cores on one side and a single fiber to illuminate on the opposite side. Imaging the multi-core side while illuminating the single core will show how much cross-talk there is between adjacent cores. As long as this is below a few percent, the cross-talk should not be an issue.

The second approach in FIG. 8C will avoid tightly packing the cores by using a lenslet array 850 shown both from the input side and a side view that lowers the apparent NA of the fibers on the object side to ˜0.035 so that it is imaged onto the retina with a 15.5 μm diameter.

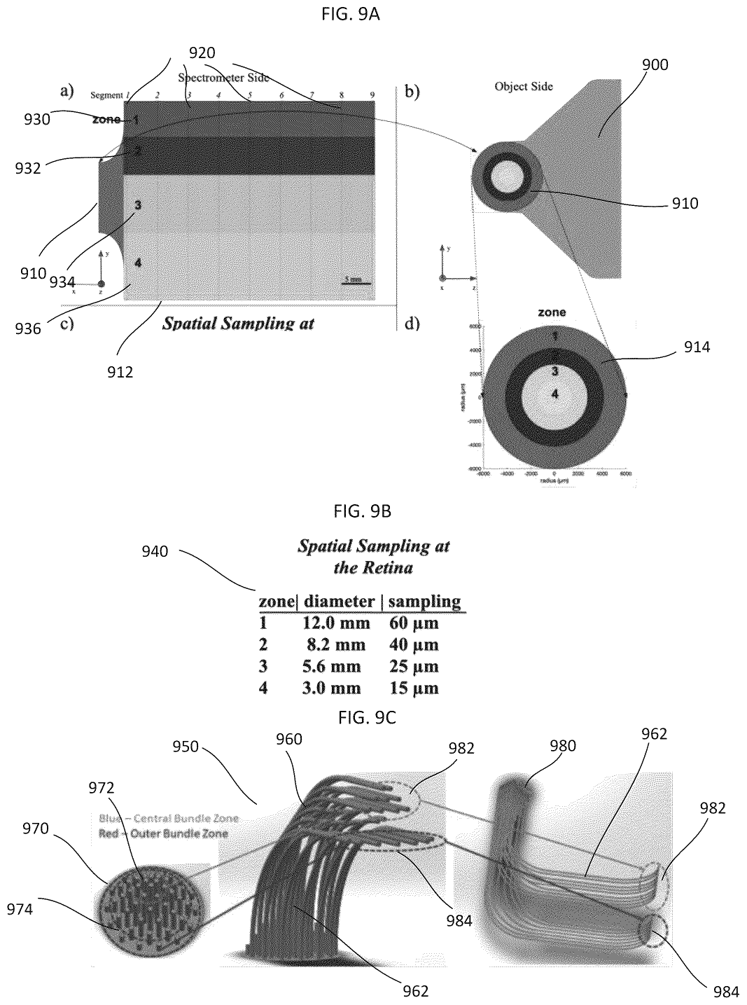

FIG. 9A shows sampling and mapping of a retina in an example 3D printed array structure 900. The array structure 900 includes an input side 910 that images the retina and an output side 912 that may be a 2-D spectrometer. In this example, the output side 912 has nine sets (Segments 1-9) of lines 920 are comprised of 9518 optical fibers with a 2.2 μm core diameter. Gaps between segments provide space to disperse light over 1444 pixels at the camera. Horizontal rows of fibers map to specific zones of the image.

The object side 910 of printed array structure 900 is imaged onto the retina. A close up image 914 shows the different zones of the retina. The zones are mapped to the areas 930, 932, 934, and 936 in the output side 912. Thus, the innermost zone in the image 914 corresponds to area 936 while the outermost zone corresponds to area 930. Each area includes fibers in all nine segments of vertical lines of fibers. FIG. 9B shows a table 940 of spatial sampling at the retina. FIG. 9C shows a zoomed in image 950 of a pattern of fibers that will be imaged onto the retina. The 4 zones have diameter and spatial sampling indicated in the table 950. The image 950 shows a 3-D rendering of a section 960 of fibers 962 of the printed structure. Individual fibers are 2.2 μm (core diameter). This layout was drawn in Solidworks which can be converted into g-code for printing. The bend radius of the fibers 962 is 500 μm, well above the critical bend radius, 208 μm. An inset 970 shows the input array on the object side 910 of the structure 900 of the fibers 962. The input array has certain fibers 972 directed toward imaging the central zone and certain fibers on an outer zone 974. An inset 980 shows the output ends of the fibers 962. One group of fiber ends 982 is directed toward output of the central zone while another group of fiber ends 984 is directed toward output of the outer zone.

The example 3-D printing approach for fabricating a waveguide array for full-field OCT enables arbitrary selection of spatial sampling on the retina. FIG. 9A shows a foveated sampling pattern that enables wide-field retinal imaging by varying the spatial sampling from the center of the FOV out. On the object side 910, there are 4 zones shown in detail in the inset image 914 that have stepped foveated sampling. The central zone, labeled 4, has a 3 mm diameter with 15 μm sampling, with successive zones having 30, 45, and 60 μm sampling, respectively. The segments 930, 932, 934, and 936 on the detector side 912 of the printed array structure 900 map to the zones. A lenslet array (not shown) is printed on the surface to efficiently couple light into the fibers. The foveated sampling pattern allows imaging a much wider field than would otherwise be possible given the CMOS sensor size. Larger CMOS sensors allow improving resolution at the periphery.

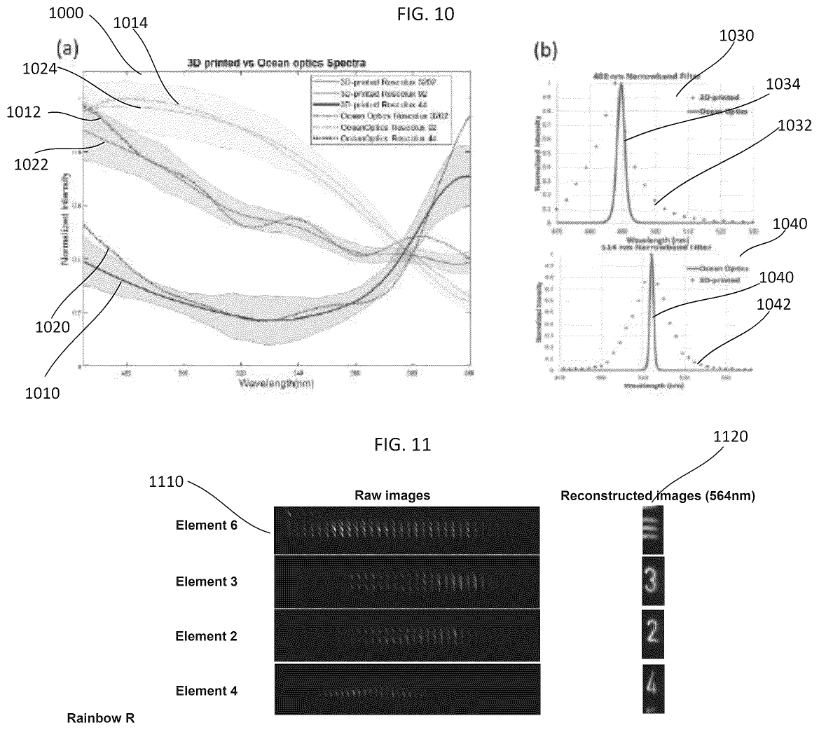

To evaluate the spectral response of an imaging spectrometer prototype similar to the system 100 in FIG. 1 incorporating the example waveguide array 200 shown in FIGS. 2A-2C, Roscolux color filters were used as a target. The results were quantitatively compared to the spectrum obtained with an Ocean Optics USB4000 visible light spectrometer. FIG. 10 shows a graph 1000 that are measurements of Roscolux 44, 92 and 3202 filters plotting normalized intensity versus wavelength. A first plot 1010 represents the example output from a 3D printed waveguide array for Roscolux 44. A second plot 1012 represents the example output from the 3D printed waveguide array for Roscolux 92. A third plot 1014 the example output from the 3D printed waveguide array for Roscolux 44. Shaded regions around the plots 1010, 1012, and 1014 represent the error (standard deviation). A first plot 1020 represents the example output from the Ocean Optics light spectrometer for Roscolux 44. A second plot 1012 represents the example output from the Ocean Optics light spectrometer for Roscolux 92. A third plot 1014 the example output from the Ocean Optics light spectrometer for Roscolux 44. The graph 1000 presents a comparison of these spectral distributions for 465 to 600 nm wavelength range.

As shown in the graph 1000, the majority of measurements from the Ocean Optics spectrometer fall within, or close to the shaded regions where the shaded regions represent the standard deviation across multiple fibers within the imaged area). All graphs were proportionally scaled at the center of spectral range, and then normalized across measurements.

A graph 1030 shows the application of a 488 nm narrowband filter. A set of dots 1032 shows the response of the example array after application of the 488 nm narrowband filter. A plot 1034 shows the response from the Ocean Optics spectrometer. A graph 1040 shows the application of a 514 nm narrowband filter. A set of dots 1042 shows the response of the example array after application of the 488 nm narrowband filter. A plot 1044 shows the response from the Ocean Optics spectrometer. From the measurement of 1 nm narrowband filters in the graphs 1030 and 1040, the FWHM of the 3D printed array used in the imaging spectrometer is significantly larger (resulting from lower dispersion and sampling—48 spectral samples) while matching expected filter wavelengths (of 488 nm and 514 nm). Lower spectral resolution/wider FWHM results in less apparent (smoothed out) spectral features in comparison to measurements from the Ocean Optics spectrometer (658 spectral channels).

Imaging results for a negative 1951 USAF Hi-Resolution Target and the color letter C were tested. Both targets were illuminated by a fiber optic illuminator (Leeds 8300) with halogen light bulb of 3300K (Pro lights, EKE 21V, 150W, MR16, Gx5.3 Base) and a diffuser. FIG. 11 shows a set of images 1110 of USAF Group 5 digits as well as element 6, which were imaged with a 4× magnification onto the input end of the example fiber array 200 in FIGS. 2A-2C. A set of reassembled images 1120 is shown in FIG. 11. In comparison to the reassembled images 1120, the raw images 1110 are stretched horizontally by the design of the example fiber array.

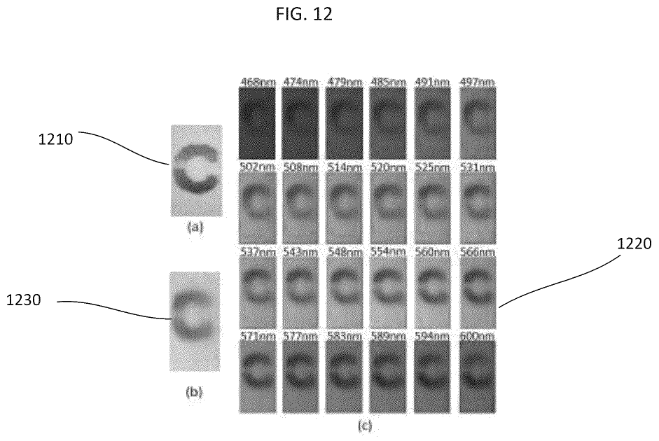

FIG. 12 shows images of color letter C, which was imaged with a magnification of 0.25× onto the input area of the example array 200 in FIGS. 2A-2C. This was done by reversing the imaging system to enable capture of the entire letter in the FOV of the example fiber bundle. An image 1210 is a ground-truth image taken with a Dino-lite microscope under the same illumination condition as the imaging spectrometer. An image 1230 is the color image after reassembly. A set of images 1220 are single-channel images of the imaging spectrometer showing 24 out of 48 channels with pseudo color at frequencies ranging from 468 nm to 800 nm.

In spite of the resulting low spatial sampling, this allows demonstration of the spectral performance of a system using the example fiber bundle array by imaging the letter C. In this example, the letter C is composed of a mixture of colors, including purple, blue, green, yellow and red. The reference color camera image 1210 and the composite color image 1230 obtained with the imaging spectrometer is shown in FIG. 12. The bottom portion of the letter C is printed purple. This is difficult to represent accurately in the prototype due to the limitations in the wavelength range of the spectrometer. Nevertheless, by selecting different spectral channels from 465 nm to 600 nm, the letter intensity clearly varies from the bottom to the top, well representing color transition.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations, and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

1. An imaging system comprising:
a light source for illuminating an object;
a structure of an array of waveguides, each waveguide having an input end to capture the object and an output end, the output end of the array of waveguides arranged having voids between the output ends allowing mapping of points of the object to the output ends; and
a 2-D image sensor capturing the output of the structure.

2. The system of claim 1, further comprising a spectrometer coupled to the outputs of the array of waveguides, the spectrometer processing the output along an orthogonal dimension, wherein the system is an optical coherence tomography system and wherein the object is one of a retina, an anterior segment of an eye, a middle ear, a tympanic membrane or an esophagus.

3. (canceled)

4. The system of claim 2, further comprising:
a dispersive component dispersing the output of the structure; and
a reimaging objective lens guiding the dispersed output to the 2-D image sensor, wherein the system is a spectrometer.

5. The system of claim 1, wherein the light source is an LED and wherein the 2-D sensor is a digital camera.

6. (canceled)

7. The system of claim 1, wherein the inputs of the waveguides are lenslets.

8. The system of claim 1, wherein the outputs of the waveguides include void spaces that allow spectral information to be spread out.

9. The system of claim 1, wherein the waveguides are optical fibers having a core and a cladding surrounding the core.

10. (canceled)

11. (canceled)

12. A waveguide structure comprising:
a plurality of waveguides, each having an input end and an output end;
an input area having an input array of the input end of the plurality of waveguides;
an output area having an output array of the output ends of the plurality of waveguides, wherein the output array has greater spacing between the ends of the waveguides than the spacing between the input ends in the input array.

13. The waveguide of claim 12, wherein the waveguides are optical fibers.

14. The waveguide of claim 13, wherein the fibers have a core and a cladding surrounding the core.

15. The waveguide of claim 14, wherein the core and cladding are one of polymer or epoxy materials.

16. The waveguide of claim 13, wherein the optical fibers are fabricated from a 3-D printing process and wherein a core diameter of the optical fibers is between 1-11 μm.

17. The waveguide of claim 12, wherein each of the plurality of waveguides include a middle segment that is bent between the input end and the output end.

18. The waveguide of claim 12, further comprising a support structure defining the input area and the output area, the support structure including at least one internal support guiding the plurality of waveguides between the input area and the output area.

19. The waveguide of claim 12, wherein the input array has an identical number of waveguides in an x and y dimension as the output array or wherein the input array has a different number of waveguides in an x and y dimension as the output array.

20. (canceled)

21. The waveguide of claim 12, further comprising a plurality of lenslets, each optically coupled to input ends of the plurality of waveguides.

22. The waveguide of claim 12, wherein the plurality of waveguides are grouped into rows of waveguides, and wherein the output area separates the rows of waveguides by a predetermined distance.

23. A method of fabricating a waveguide array comprising:
providing a 3-D print file for a waveguide structure including:
a plurality of waveguides, each having an input end and an output end;
an input area having an input array of the input end of the plurality of waveguides; and
an output area having an output array of the output ends of the plurality of waveguides, wherein the output array has greater spacing between the ends of the waveguides than the spacing between the input ends in the input array; and
printing the waveguide structure from the 3-D print file by polymerizing a photoresin via a 2-Photon Polymerization (2PP) additive system.

24. The method of claim 23, wherein the waveguides are optical fibers and wherein the printing includes either printing a core of the fibers and wherein the method further comprises applying a cladding material to the core or printing a cladding of the fibers and wherein the method further comprises applying a core material to the cladding to define a core of the fibers.

25-31. (canceled)

32. The method of claim 23, wherein the plurality of waveguides are grouped into rows of waveguides, and wherein the output area separates the rows of waveguides by a predetermined distance.
